(19) United States
(12) Patent Application Publication
(10) Pub. No.: US 2024/0193366 A1
(43) Pub. Date: Jun. 13, 2024

(54) ACCELERATED INFORMATION EXTRACTION THROUGH FACILITATED RULE DEVELOPMENT

(71) Applicant: SRI International, Menlo Park, CA (US)

(72) Inventors: Dayne Brian Freitag, Descanso, CA (US); John Cadigan, San Diego, CA (US); John Joseph Niekrasz, Bonita, CA (US); Robert Vincent Sasseen, San Diego, CA (US)

(21) Appl. No.: 18/534,210

(22) Filed: Dec. 8, 2023

Related U.S. Application Data
(60) Provisional application No. 63/386,769, filed on Dec. 9, 2022.

(51) Int. Cl. G06F 40/289; G06F 40/284

(52) U.S. Cl. CPC G06F 40/289; G06F 40/284

(57) ABSTRACT

A computing system is configured to process a first document using an anchor rule, wherein the anchor rule identifies tokens for a domain. The computing system is further configured to identify, using the anchor rule, a first set of phrases from the first document that match the tokens. The computing system is further configured to receive a first selection from a first subset of the first set of phrases. The computing system is further configured to determine, based on the first selection, a word list, wherein the word list is a list of words ranked by rate of appearance in the first document. The computing system is further configured to process, based on the word list, a second document to extract one or more points of information from the second document.

This application claims the benefit of U.S. Provisional Patent Application No. 63/386,769, filed 9 Dec. 2022, the entire contents of which is incorporated herein by reference.

### TECHNICAL FIELD

This disclosure relates to computing systems and, more specifically, to an information extraction system.

### BACKGROUND

Machine learning systems may be used to process documents and extract a variety of information. For example, a machine learning system can be trained to perform information extraction on documents to extract names, dates, or more specific kinds of information from the documents (e.g., information specific to a given business case). The models that underpin information extraction can be developed to extract a variety of types of information from documents. In many cases, an organization may want to develop an information extractor for performing IE on a variety of documents and obtaining information from the documents. The organization may wish to develop an extractor that includes one or more language processing models created to extract information from documents and collections of information. For example, an organization may want to develop an information extractor that includes a natural language model to track fashion trends across social media posts. The organization may require an information extractor capable of processing large quantities of data (e.g., posts on social media sites) and output trends identified by the extractor.

### SUMMARY

In general, this disclosure describes techniques for improving information extraction (IE) processes though iteratively processing a document using a word list, presenting a subset of matching phrases to a user for annotation, processing the selection to generate an updated word list, and applying the word list to the document. An organization may seek to develop an information extraction model capable of processing large volumes of data (e.g., a corpus that includes thousands of scientific papers) and extracting information useful to the organization.

Rather than expending the time or resources to develop an information extractor through conventional machine learning techniques, an organization may employ the iterative processing of a document using word lists. For example, developing a machine learning-based extractor model for IE (which may be referred to herein as an “IE model”) through traditional annotation techniques can be exceedingly expensive and time-consuming. In some circumstances, some of the most advanced language processing models may require several months, substantial computing resources, and hundreds of millions of dollars to develop. An alternative approach is to develop an IE model that is based on rules and/or a finite state machine. This alternative approach involving the IE model may be comparatively faster, as accurate as, and less costly to develop than a machine learning-based language model. Thus, in many cases organizations may be forced to choose between spending substantial time and resources developing a high-performing language model for IE through annotation and training of a machine learning model, or quickly and inexpensively developing a IE model based on rules that performs well but may yield slightly reduced recall.

A possible solution is to create an initial finite rules-based model for information extraction, updating the rules-based IE model based on user feedback on annotations performed by rules-based IE model, and training a machine learning language model using annotations generated using the rules-based model. For instance, as part of an information extraction system one or more developers may create an initial rules-based IE model for information extraction. The information extraction system may use the initial rules-based IE model to process a series of documents and extract information from the documents. The information extraction system may use the rules-based IE model to process the documents and then provide a subset of the output of the rules-based IE model to a user for review. For example, information extraction system may use the rules-based IE model to generate a list of words and relations between the words that comprise word patterns extracted from the document processed by the rules-based IE model and provide the list of words and relations to the user. The information extraction system receives a selection of one or more of the word patterns from the provided subset and updates the rules-based model based on the user selection. The information extraction system may iteratively perform the preceding steps until the rules-based model reaches an acceptable level of performance (e.g., accurately producing 90% of the extractions that an optimal ML model might produce). Based on the rules-based model reaching an acceptable level of performance, the information extraction system trains a machine learning-based natural language processing model using the rules-based model. The information extraction system may then process further documents using the machine learning model to perform information extraction.

In an example, a method includes processing, by a computing system, a first document using an anchor rule, wherein the anchor rule identifies tokens for a domain; identifying, by the computing system and using the anchor rule, a first set of phrases from the first document that match the tokens; receiving, by the computing system, a first selection from a first subset of the first set of phrases; determining, by the computing system and based on the first selection, a word list, wherein the word list is a list of words ranked by a rate of appearance in the first document; processing, by the computing system and based on the word list, a second document to extract one or more points of information from the second document.

In another example, a computing system includes a memory and one or more programmable processors in communication with the memory and configured to process a first document using an anchor rule, wherein the anchor rule identifies tokens for a domain; identify, using the anchor rule, a first set of phrases from the first document that match the tokens; receive a first selection from a first subset of the first set of phrases; determine, based on the first selection, a word list, wherein the word list is a list of words ranked by a rate of appearance in the first document; and process, based on the word list, a second document to extract one or more points of information from the second document.

In yet another example, a non-transitory computer-readable medium includes instructions configured to cause one or more processors to process a first document using an anchor rule, wherein the anchor rule identifies tokens for a domain; identify, using the anchor rule, a first set of phrases from the first document that match the tokens; receive a first selection from a first subset of the first set of phrases; determine, based on the first selection, a word list, wherein the word list is a list of words ranked by a rate of appearance in the first document; and process, based on the word list, a second document to extract one or more points of information from the second document.

### BRIEF DESCRIPTION OF DRAWINGS

FIG. 1 is a block diagram illustrating an example information extraction system for extracting information from unstructured data, in accordance with one or more techniques of this disclosure.

FIG. 2 is a block diagram illustrating an example computing system, in accordance with one or more techniques of this disclosure.

FIG. 3 is a diagram illustrating example relations, in accordance with one or more techniques of this disclosure.

FIG. 4 is a diagram illustrating an excerpt of a rule set, in accordance with one or more techniques of this disclosure.

FIG. 5 is a diagram illustrating an example sequence of operations of authoring a rule set, in accordance with one or more techniques of this disclosure.

FIG. 6 is a flow chart illustrating an example operation of an information extraction system, in accordance with one or more techniques of this disclosure.

### DETAILED DESCRIPTION

The systems and techniques describes in this disclosure may perform data analytics on data that includes natural language text. The systems and techniques may use rule frameworks to perform information extraction (IE) from data such as unstructured data. In some examples, information extraction may include converting statements in natural language into structured records suitable for downstream computation. In addition, the system and techniques may facilitate the human rule creation with automation such as machine learning (ML) applied to target documents and rules in development. For instance, the system and techniques may determine specific statements from data and convert human-language statements or assertions into structured records, through IE. The disclosed system and techniques may reduce the often prohibitively extensive labor requirements for developing custom machine learning-based information extractors.

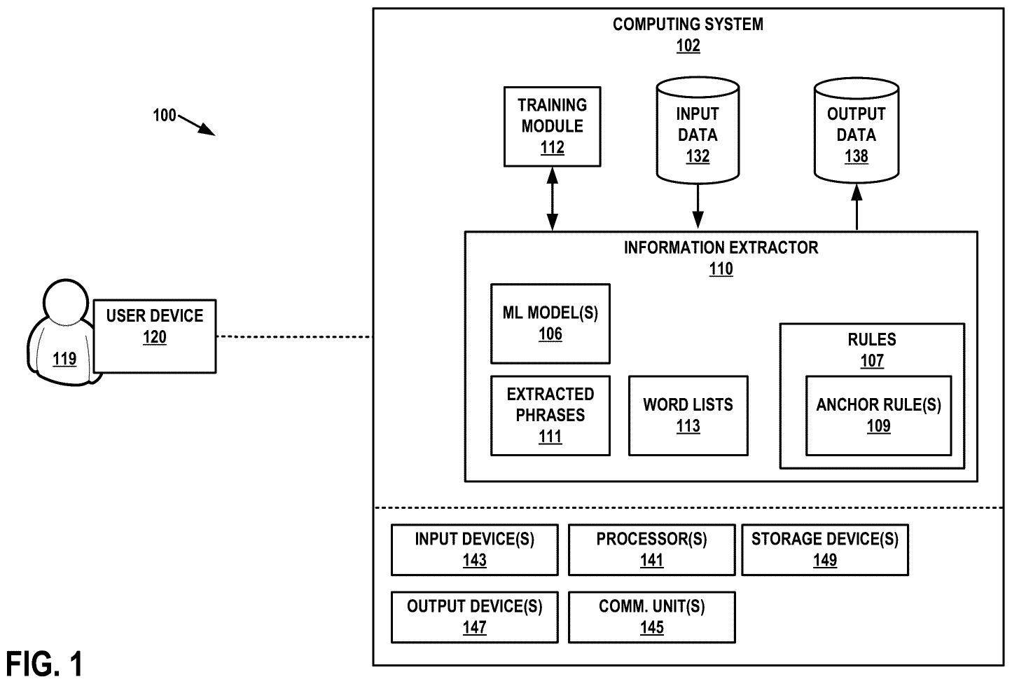

FIG. 1 is a block diagram illustrating an example information extraction system for extracting information from unstructured data, in accordance with one or more techniques of this disclosure. In the example of FIG. 1, an information extraction system 100 includes a user device 120 and a computing system 102. Information extraction system 100 includes one or more computing systems for performing information extraction such as computing system 102. Computing system 102 may represent any device capable of executing an information extractor such as information extractor 110. For example, computing system 102 may include one or more devices such as workstations, laptops, desktop computers, servers, virtualized computing environments, virtual machines, worker nodes, tablet computers, mobile phones, gaming systems, etc. Computing system 102 includes processors 141, input devices 143, communication units 145 (illustrated as “COMM. UNIT(S) 145” in FIG. 1), output devices 147, and storage devices 149.

Computing system 102 includes one or more processors such as processors 141. Processors 141 may include one or more physical and/or virtualized processors. For example, processors 141 may include multiple processors each with multiple physical or logical cores. Processors 141 may be configured to execute the instructions of one or more programs or processes of computing system 102.

Computing system 102 includes input devices 143 and output devices 147. Input devices 143 and output devices 147 may include one or more devices that enable a user to interact with computing system 102. For example, input devices 143 may include one or more types of input devices such as touch interfaces, keyboards, mice, microphones, and other types of input devices. Output devices 147 may include one or more types of output devices such as displays, speakers, haptic motors, and other types of output devices.

Computing system 102 includes communication units 145. Communication units 145 may include one or more types of communications units or interfaces such as ETHERNET, BLUETOOTH, fiber optic, WIFI, and other types of communication interfaces. Communication units may enable computing system 102 to communicate with other computing devices and systems of information extraction system 100 such as user device 120.

Computing system 102 includes storage devices 149. Storage devices 149 may include one or more types of storage such as hard disk drives, solid state drives, magnetic tape storage, cloud storage, and other types of storage and storage devices. Storage devices 149 may store instructions for one or more processes of computing system 102 such as instructions for information extractor 110 and training module 112.

Information extractor 110 may be one or more programs, processes, or other types of software components. Information extractor 110 may be configured to extract information from data such as scientific papers, business documents, news reports, social media messages, and other types of written information. For example, information extractor 110 may be configured to extract information regarding solar panel efficiency from a plurality of academic papers included in input data 132.

Input data 132 includes one or more types of information consumed by information extractor 110. Input data 132 may include types of information such as documents, social media posts, computer-generated written information, and other types of information. Input data 132 may be provided to information extraction system 100 for information extractor 110 to consume and process. For example, computing system 102 may cause information extractor 110 to consume input data 132 and extract information from input data 132 using one or more types of information extraction models such as rules 107.

An organization may seek to develop an information extractor such as information extractor 110 of information extraction system 100 to process data. An organization may use information extraction system 100 to process large numbers of documents and identify trends across the documents in a manner that would be impractical for human operators to conduct. For instance, an organization may seek to develop information extractor 110 to process scientific documents obtained from a database or other source and extract information regarding developments in one or more scientific fields across various time intervals (e.g., it may be impractical to use human analysts to process thousands of documents across various time intervals—e.g., months, years, decades, etc.—to identify trends across those documents). In another example, an organization may seek to develop information extractor 110 to process academic documents regarding solar panel development and extract information about changes in the efficiency of solar panels over time.

Information extraction system 100 may use information extractor 110 to perform information extraction on one or more documents or pieces of information such as input data 132. Input data 132 may include a plurality of documents that comprise a corpus for processing by information extractor 110. Information extraction system 100 may cause information extractor 110 to extract information from a plurality of documents of input data 132 provided to information extraction system 100. Information extractor 110 may perform information extraction to extract types of information from input data 132 such as patterns (e.g., patterns across one or more of the documents), particular points of information (e.g., data points such as changes in rated solar panel efficiency), and other types of information.

Information extractor 110 may extract information from one or more types of input data 132. For example, information extractor 110 may process and extract information from data such as websites, books, magazines, social media, news websites, emails, software code, spreadsheets, academic databases of papers, and other types of data in any digital representation of text/natural language. In addition, information extractor 110 may scan the data of input data 132 and perform text recognition to obtain the natural text data from input data 132.

Information extractor 110 may include one or more types of models to perform the information extraction. Information extraction extractor 110 may perform information extraction using a machine learning-based model such as ML models 106. ML models 106 may include one or more types of machine learning models trained to extract one or more types of information. For instance, ML models 106 may include a natural language processing model trained to extract particular words and phrases and to identify relations among the extracted words and phrases. In some examples, ML models 106 may include an autoregressive deep learning neural network trained to perform one or more language tasks such as generating probabilities of a series of words. ML models 106 may predict tokens (e.g., a sequence of characters) and the order in which tokens will appear. For example, ML models 106 may generate a sentence through probabilistic prediction of words and the order in which they should appear (e.g., provided “The quick brown fox jumps over . . . ” ML models 106 may predict the next words should be “the lazy dog”).

ML models 106 may include one or more machine learning models used by information extractor 110 to perform information extraction. For example, ML models 106 may include one or more types of machine learning models such as one or more of a Deep Neural Network (DNN) model, Recurrent Neural Network (RNN) model, Long Short-Term Memory (LSTM) model, and/or transformer model, among other types of machine learning models. ML models 106 may also include one or more types of natural language processing models trained to extract information. For example, ML models 106 may be configured and trained to perform information extraction (IE) on documents and other sources of written information (e.g., slideshows). For example, ML models 106 may be configured to perform IE on scientific documents to extract and analyze information regarding the development of one or more technologies such as developments in solar panel efficiency and performance. ML models 106 may extract information from documents included in data inputted to ML system 110 such as input data 132.

Information extractor 110 includes rules 107. Rules 107 may represent one or more rules-based models such as finite-state models and/or finite state machines similarly configured to perform information extraction. In some examples, rules 107 may include a set of rules that specify a mathematical model (e.g., a model configured to perform probabilistic prediction of words and their sequence). Rules 107, as opposed to an ML model such as a neural network, may be comprised of rules written by human developers to enable rules 107 to achieve a sought output (e.g., classified text). In an example, rules 107 include a finite-state model configured to extract information regarding fashion trends from a plurality of social media posts provided to information extractor 110. In another example, rules 107 include a plurality of rules that extract one or more pieces of information when applied to information such as input data 132.

An organization, when configuring information extraction system 100 to perform information extraction, may choose whether to use machine-learning based models or rule-based models as the basis for information extractor 110 in a conventional information extraction system. In a conventional system, an organization would have to weigh the benefits of using a machine learning model-based information extractor compared to a finite state rules-based information extractor. Typically, a machine learning model-based information extractor provides superior performance to a rules-based information extractor but requires substantial time and computing resources to train. For example, an ML information extractor may be capable of processing vast amounts of data and sufficiently flexible to respond to a wide range of requests (e.g., capable of extracting a variety of types of information instead of a single or handful of types of information) but require substantial computing, financial, human, and temporal resources to develop. As an alternative, a rules-based information extractor may be far less resource-intensive to develop (e.g., some rules-based IE models may only require a handful of developers and a few days to create). However, a rules-based IE model may become unwieldy to develop beyond a certain scale. In addition, a rules-based IE model may perform fewer extractions than an ML-based information extractor as further development resources are expended.

A solution is to create an initial finite rules-based model for information extraction, updating the model based on user feedback on annotations performed by rules-based model, and training a machine learning language model using the annotations. For instance, one or more developers may create an initial rules-based model for information extraction and process a series of documents through the rules-based model. A machine-learning system may cause the rules-based model to process the documents and provide a subset of the output to a user for review. For example, the rules-based model may provide a list of words and relations between the words that comprise word patterns extracted from the document processed by the rules-based model to the user. The machine-learning system receives a selection of one or more of the word patterns from the provided subset and updates the rules-based model based on the user selection. The machine-learning system may iteratively perform the preceding steps until the rules-based model reaches an acceptable level of performance. Based on the rules-based model reaching an acceptable level of performance, the machine learning system trains a machine learning-based natural language processing model using the finite-state model. The machine learning system may then process further documents using the machine learning model to perform information extraction.

In accordance with various aspects of the techniques described in this disclosure, information extraction system 100 includes a rules-based model iteratively modified through extraction of words and phrases for use in identifying relations within a corpus. Information extraction system 100 may train one or more machine learning models for information extraction using a refined version of the rules-based model. For instance, one or more developers may create an initial rules-based model such as rules 107 for information extraction and process input data 132 through rules 107. Information extractor 110 may use rules 107 to process input data 132 and provide a subset of the output to a user such as user 119 for review. For example, information extractor 110, via rules 107, may provide a list of words and relations between the words that comprise word patterns extracted from input data 132 by information extractor 110 to user 119 via user device 120. Computing system 102 receives a selection of one or more of the word patterns from the provided subset and causes training module 112 to update rules 107. Information extraction system 100 may iteratively perform the preceding steps until rules 107 reaches an acceptable level of performance. Based on rules 107 reaching an acceptable level of performance, training module 112 trains one or more machine learning models of ML models 106. Information extraction system 100 may then process further documents using ML models 106 to perform information extraction.

Computing system 102 may use the one or more finite-state models to train machine learning models. For example, computing system 102 may use rules 107 to generate annotations used to configure one or more ML models of information extractor 110. For example, computing system 102 may use pattern matches and word lists generated by rules 107 to improve the performance and accelerate the training of one or more ML models such as ML models 106.

Rules 107 includes one or more “anchor rules” in anchor rules 109. Rules 107 may include anchor rules 109 that are used as an initial state or set of rules for training ML models 106 and for processing input data 132. For example, user 119 may create anchor rules 109 when initially configuring rules 107 and information extractor 110. User 119 may create anchor rules 109 to form a basis for rules 107. In addition, computing system 102 may update one or more of rules 107 in response to user feedback. Rules 107 may include pattern-based anchoring rules as well as seed-based anchoring rules. Information extractor 110 may use one or more of anchor rules 109 to quickly extract tokens from a document corpus. For example, information extractor 110 may use anchor rules 109 to tokenize a corpus of input data 138 as part of extracting information from the corpus. Information extractor 110 may use anchor rules 109 to, as part of tokenizing the corpus, identify tokens for a particular domain of the corpus.

In operation, information extractor 110 processes a first document using an anchor rule of anchor rules 109, wherein the anchor rule identifies tokens for a domain. An anchor rule may be a rule that is relatively simple and used to find candidate entity elements that are sufficiently similar to the tokens or results sought from information extractor 110. For example, anchor rules 109 may include a rule that matches any numeric token by design and used to inspect candidates for further rule refinement. In another example, an anchor rule of anchor rules 109 may capture an aspect of the context of a class of words that is sought from input data 132. In some examples, anchor rules 109 include one or more rules such as entity expressions used in assertions that are directed towards one or more targets such as: quantitative claims or observations in the scientific literature; relationships among people and organizations reported in the news; the parties and findings in legal documents involved in litigation; or products, business entities, prices, in documents detailing business transactions; and or other domains involving textual communication

Information extractor 110 may process a first document received as input data 132. In an example, computing system 102 provides the first document to information extractor 110 as part of input data 132 for consumption and processing by information extractor 110. Information extractor 110 processes the first document using anchor rules 109 of the rules-based model of rules 107. Information extractor 110 may process the documents using anchor rules 109 to generate a first set of extracted information. Information extractor 110 may process input data 132 by applying the rules of anchor rules 109 to input data 132. For example, information extractor 110 may process the documents to extract information regarding the occurrence and relations among a plurality of words of input data 132. As part of processing the first document of input data 132, information extractor 110 tokenizes the first document into one or more tokens, where each token of the one or more tokens includes a sequence of characters grouped together.

Information extractor 110 identifies, using anchor rules 109, a first set of phrases from the first document that match the tokens from the tokenized first document. Information extractor 110 identifies a first set of phrases such as one or more phrases within extracted phrases 111 based on the tokens identified using anchor rules 109. Extracted phrases 111 may be a collection or storage of phrases extracted from the corpus of documents processed by information extractor 110. In addition, information extractor 110 may process a plurality of documents to maximize the number of words and phrases extracted. For example, information extractor 110 may process a plurality of documents and extract words and phrases for presentation to user 119. Information extractor 110 may identify phrases based on the tokens identified from the first document and store them in extracted phrases 111 for further processing and analysis. Information extractor 110 may identify phrases that are combinations of tokens and/or that are based on relations between tokens. For example, information extractor 110 may identify phrases that are names prefixed with an honorific using an anchor rule of anchor rules 109 that operates as a phrasal extractor. In addition, information extractor 110 may identify phrases based on the relatedness of the phrases to the information sought to be extracted from the first document.

Information extractor 110 may select a subset of extracted phrases 111 and provide them to a user such as user 119 for analysis. In some examples, information extractor 110 may select a subset of extracted phrases 111 that are representative of the types of phrases extracted from the first document. In another example, information extractor 110 may select a subset of extracted phrases 111 based on the relatedness of the phrases to the information sought from the first document. Information extractor 110, based on the selection of the subset of phrases, provides the phrases to user device 120 for analysis by user 119.

Information extraction system 100 also includes, as shown in the example of FIG. 1, user device 120. User device 120 may include one or more types of devices such as laptop computers, desktop computers, servers, workstations, virtual machines, tablet computers, smartphones, video game systems, wearable computers (e.g., virtual reality headsets, augmented reality headsets, mixed reality headsets, smart glasses, etc.), and other types of computing devices. User device 120 may enable a user such as user 119 to interact with data received from computing system 102. For example, information extractor 110, responsive to the processing of input data 132 using rules 107, may provide a subset of the processed data to user 119 for analysis. Information extractor 110 may provide a subset of output data 138 to a user device such as user device 120 for analysis by user 119.

Computing system 102 may receive a first selection from a first subset of the first set of phrases from user device 120. Computing system 102 may receive a first selection of phrases from the first subset of phrases provided to user device 120. For example, computing system 102 may receive a first selection of phrases that includes a portion of the phrases in the first subset of phrases.

Information extractor 110 determines, based on the first selection received from computing device 120, a word list such as a word list of word lists 113, wherein the word list is a list of words ranked by a rate of appearance in the first document. Information extractor 110 may determine the word list of word lists 113 based on the phrases of the first selection of phrases received from computing device 120. For example, information extractor 110 may derive a word list from the first selection of phrases that includes the words within the selection of phrases.

Information extractor 110 may process based on the word list, a second document to extract one or more points of information from the second document. Information extractor 110 may process the second document in response to receiving the second document in input data 132. Information extractor 110 may process the second document using rules 107 that have been updated based on the selection of the word list.

Information extractor 110 may process the second document using one or more machine learning models trained using a refinement of rules 107. For instance, information extractor 110 may process the second document using a machine learning model such as a machine learning model of ML models 106. Information extractor 110 may process input data 132 using one or more machine learning models in response to a user indication that rules 107 has reached a state of acceptable performance for use in training the machine learning models.

Information extractor 110 may train ML models 106 using training module 112. Information extractor 110 may cause training module 112 to train ML models 106 in response to rules 107 reaching an acceptable level of performance in extracting information from input data 132. Training module 112 may be a process, module, plugin, or other type of software configured to train machine learning models. For example, training module 112 may be configured to generate annotations for use in training one or more machine learning models of ML models 106. Training module 112 may generate annotations that are based on pattern matches of rules 107. In another example, training module 112 may generate embeddings for ML models 106 based on the rules of rules 107. Responsive to generating the annotations and embeddings, training module 112 trains ML models 106. Training module 112 may train ML models 106 and/or modify ML models 106 based on the generated annotations and embeddings. Further, training module 112 may apply other types of machine-learning to train any of the ML models described herein. For example, machine learning system 110 may apply one or more types of neural networks to train ML models 106.

The techniques of this disclosure may provide one or more practical advantages. For example, the use of rules 107 to generate annotations and embeddings for ML models 106 may enable faster and less resource-intensive training of the ML models 106 than through traditional methods of training ML models. In another example, the iteration of processing documents and providing the results to user 119 by computing system 102 may improve the accuracy and speed of updating rules 107 (e.g., a rule set outside of anchor rules 109) and training ML models 106. In yet another example, the use of assertions that are comprised of related tokens (e.g., metrics and values) may enable faster and more efficient extraction of information from documents by information extractor 110.

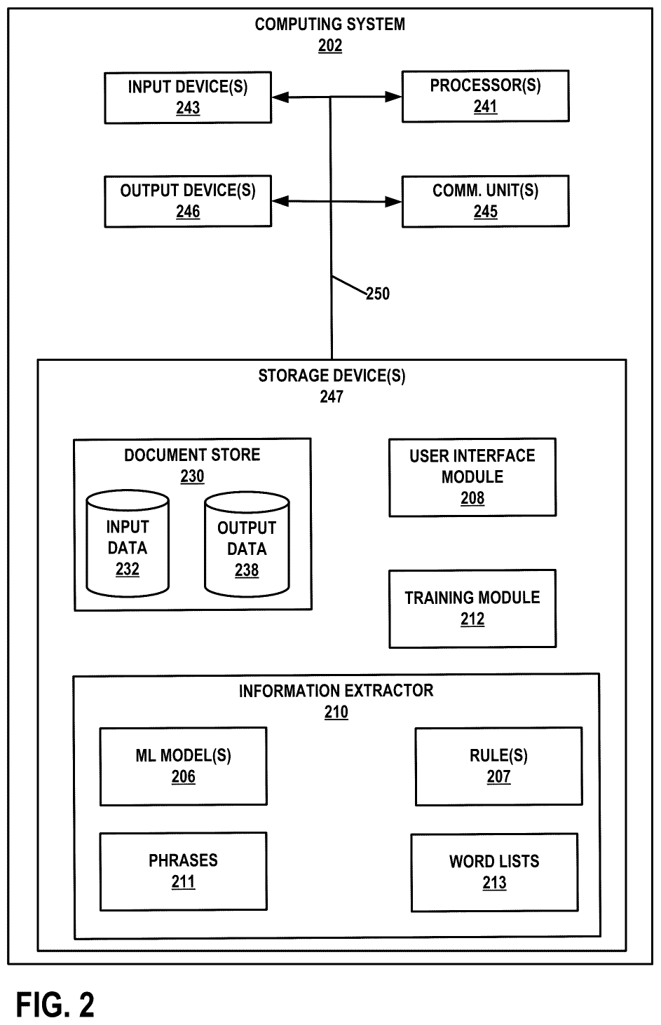

FIG. 2 is a block diagram illustrating an example computing system 202, in accordance with one or more techniques of this disclosure. Computing system 202 may be similar to computing system 102 as illustrated in FIG. 1 and perform similar functions. Computing system 202 includes processors 241, input devices 243, communication units 245 (illustrated as “COMM. UNIT(S) 245” in FIG. 2), output devices 246, storage devices 247, and interconnect 250.

Computing system 202 includes processors 241. Processors 241 may include one or more physical and/or virtualized processors. In addition, processors 241 may include one or more physical and/or logical processing cores such as “efficiency” cores and “performance” cores. Processors 241 may execute instructions and provide an execution environment for one or more programs of computing system 202.

Computing system 202 includes input devices 243 and output devices 246. Input devices 243 may include one or more input devices such as microphones, keyboards, mice, touchscreens, and other types of input devices. Output devices 246 may include one or more types of output devices such as displays, touchpads, virtual reality headsets, augmented reality headsets, speakers, haptic motors, and other output devices. Computing system 202 may leverage input devices 243 and output devices 246 to facilitate user interaction with computing system 202. For example, computing system 202 may receive user input via input device 243 and provide output via output devices 246.

Computing system 202 includes communication units 245. Communication units 245 may be one or more types of communication units and/or interfaces such as WIFI, ETHERNET, fiber optic, or other type of communication interface. Communication units 245 may enable computing system 202 to communicate with other computing systems and devices such as user devices 120 as illustrated in FIG. 1.

Computing system 202 includes interconnect 250. Interconnect 250 may include one or more types of communication interface or interconnect that connects one or more components of computing system 202. For example, interconnect 250 may facilitate communication between processors 241 and storage devices 247.

Computing system 202 includes storage devices 247. Storage devices 247 may be one or more types of storage devices such as hard disk drives, solid state drives, tape drives, volatile flash memory, non-volatile flash memory, and cloud storage. Storage devices 247 may store one or more programs and processes executed by processors 241. For example, storage devices 247 may store the instructions of information extractor 210.

Storage devices 247 include information extractor 210. Information extractor 210 may be a program or process configured to extract information from documents and organize the extracted information. Information extractor 210 may be similar to information extractor 110 illustrated in FIG. 1 and perform similar functions. For example, information extractor 210 may, based on receiving a corpus that includes a plurality of scientific papers, extract trends from among the scientific papers.

Storage devices 247 includes document store 230. Document store 230 may be a database, storage drive, or other type of storage within storage devices 247. Document store 230 may store data for processing by information extractor 210 and the output of information extractor 210. For example, document store 230 may store a corpus that includes a plurality of documents for processing by information extractor 210. In some examples, document store 230 may store streaming data and stream the data to information extractor 210 for processing. In an example, computing system 202 streams data from external sources via communication units 245 and provides the data to information extractor 210 as it is received by communication units 245. Document store 230 includes input data 232 and output data 238. Input data 232 may be similar to input data 132 as illustrated in FIG. 1 and include similar data such as documents to be processed. In some examples, input data includes training data for training ML models 206 and improving the performance of rules 207. Output data 238 may be similar to output data 138 as illustrated in FIG. 1 and include similar data such as information extracted from input data 232. In some examples, output data 238 may include the results of information extractor 210 processing training data of input data 232.

Information extractor 210 includes rules 207. Rules 207 may be similar to rules 107 as illustrated in FIG. 1 and perform similar functions. In addition, rules 207 may include one or more finite-state models and/or finite-state machines. Rules 207 may include one or more “anchor rules” that are rules within the rules-based model used to extract information. Rules 207 may include one or more anchor rules that are used as starting rules for information extraction. For example, rules 207 may include an anchor rule configured to maximize the number of matches within a corpus. In another example, rules 207 may represent a finite-state machine configured to extract information from a corpus and determine historical trends among the documents within the corpus. Rules 207 may be configured by a developer such as user 119 as illustrated in FIG. 1 and used to bootstrap one or more machine learning models. For example, user 119 may draft an initial set of rules within the model of rules 207 and cause information extractor 210 to perform information extraction using rules 207. In another example, computing system 202 may cause information extractor 202 to perform information extraction using an updated rules-based model of rules 207.

Information extractor 210 includes phrases 211. Phrases 211 may include a store of phrases extracted from input data 232. Phrases 211 may include extracted data that include word relationships extracted from input data. For example, phrases 211 may include scientific statements extracted from input data 232 that include scientific statements that are composed of measured values and metrics of the values (e.g., “12” and “amps”, respectively). Phrases 211 may be extracted form input data 232 by information extractor 210 using a rules-based model of rules 207. Information extractor 210 may use phrases 211 in extracting further data from input data 232 and aiding user 119 in refining rules 207.

Information extractor 210 includes word lists 213. Word lists 213 may include a plurality of words and/or lexicons and be similar to word lists 113 as illustrated in FIG. 1. Information extractor 210 may perform further analysis, on a corpus such as input data 232, to extract context and phrases from the corpus. For example, information extractor 210 may apply regular expression at the token level rather than at the character level to generate word lists 213. Information extractor 213 may provide information regarding word lists 213 to user 119 for analysis. For example, information extractor 210 may provide the information to user 119 for user 119 to further refine rules 207 based on one or more relationships identified by information extractor 210.

Information extractor 210 may perform a process of elaboration to locate regions within a corpus of input data 232. In addition, information extractor 210 may perform the process to identify relationships within the corpus. Information extractor 210 may use one or more machine learning models or processes such as embeddings in ML models 206, semantic processors, NLP engines, and other processes to extract the relationships within the corpus.

Information extractor 210 includes ML models 206. ML models 206 may be similar to ML models 106 as illustrated in FIG. 1. ML models 206 may include one or more machine learning models trained to perform information extraction. For example, ML models 206 may include a neural network trained to perform information extraction. ML models 206 may be trained using one or more rules-based models in rules 207. For example, computing system 202 may cause training module 212 to generate annotations and embeddings using a corpus and rules 207 to train ML models 206. Computing system 202, responsive to the generation of embeddings and annotations of training data or other data, may cause training module 212 to update one or more machine learning models within ML models 206.

Storage devices 247 include training module 212. Training module 212 may be similar to training module 112 as illustrated in FIG. 1 and provide similar functionality. Training module 212 may be a process, program, plugin, module, or other type of software component configured to modify and train information extraction models. Training module 212 may train ML models 206 using annotations of input data 232 processed by rules 207. In addition, training module 212 may modify ML models 206 with embeddings generated by information extractor 210 using rules 207.

Training module 212 may aid in developing a rule set such as the rule sets used in rules 207. Training module 212 may use the identified relationships among words identified during the elaboration process to generate new rule sets for rules 207. In an example, information extractor 210 identifies a plurality of relationships among words within a corpus of input data 232. Training module 212 generates, based on the identified relationships, a rules set that identifies such relationships in documents such as the documents or corpus of input data 232. In some examples, training module 212 provides the identified relationships to user 119 for user 119 to develop a rules set. Training module 212, based on the generation of the rules set, updates rules 207 using the rules set to enable rules 207 to better extract sought information from input data 232.

Storage devices 247 include user interface module 208. User interface module 208 may be a process, plugin, module, or other type of software component. User interface module 208 may perform one or more functions that enable a user to interact with and configure information extractor 210. For example, user interface module 208 may generate a graphical user interface and provide data regarding the graphical user interface to another computing device or system such as user device 120 as illustrated in FIG. 1. In another example, user interface module 208 may receive data regarding user interaction and modify one or more aspects of information extractor 210 in response to the user interaction. For example, user interface module 208 may enable user 119 to modify one or more rules within rules 207.

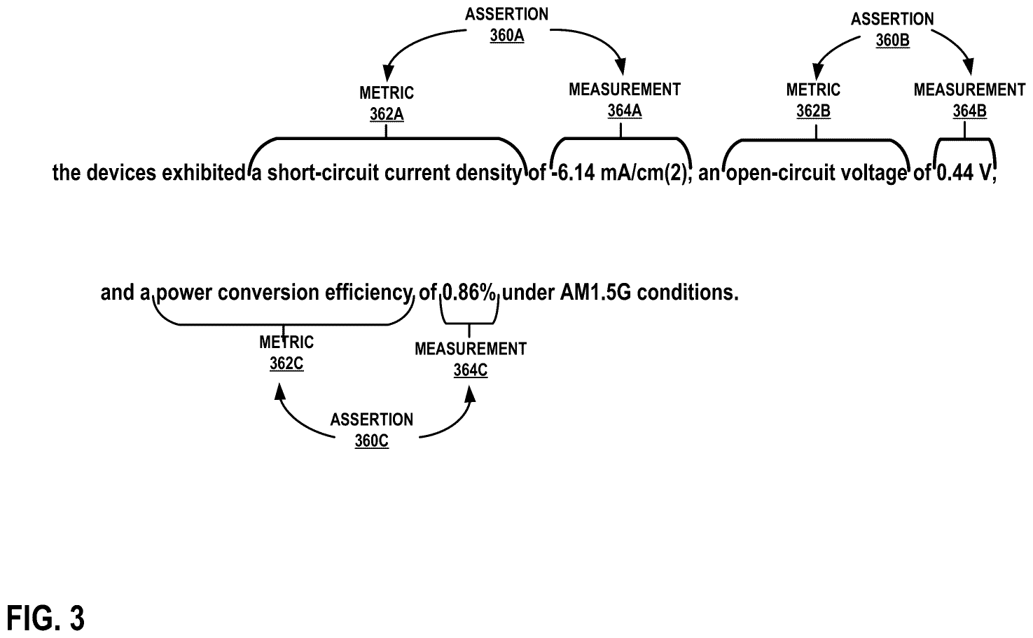

FIG. 3 is a diagram illustrating example relations, in accordance with one or more techniques of this disclosure. For the purposes of clarify, FIG. 3 will be discussed in the context of FIG. 1. FIG. 3 includes assertions 360A-360C (hereinafter “assertions 360”). Assertions 360 may include one or more types of relations among words within a corpus such as documents within input data 132. For example, assertions 360 may represent one or more semantic relations between words and phrases. In another example, assertions 360 are relations between sections of a sentence from scientific literature.

In the example of FIG. 3, assertions 360 include relations between metrics 362A-362C (hereinafter “metrics 362”) and measurements 364A-364C (hereinafter “measurements 364”). Metrics 362 are metrics of various physics and engineering attributes, such as short-circuit current density, open-circuit voltage, and power conversion efficiency as illustrated in FIG. 3. Measurements 364 are the value of the respective metrics 362. For example, as illustrated in FIG. 3, the metric of measurement 364A is “−6.14 mA/cm(2)”. Both metrics 362 and measurements 364 are examples of entities, which are words or phrases of a particular semantic type.

Information extractor 110 may perform information extraction on data such as input data 132 using rules 107. For example, information extractor 110 may apply the one or more rules within rules 107 in order to perform information extraction of a corpus of input data 132. In an example, information extractor 110 receives a corpus that includes digital scans of scientific research papers. Information extractor 100 then applies one or more other rules of rules 107 to identify tokens from the corpus of input data 132 that are semantically useful units of grouped-together character.

Information extractor 110 may process input data 132 using anchor rules 109. Information extractor 110 may use anchor rules 109 that are high-recall expressions to extract comparatively large number of candidate expressions or tokens. For example, information extractor 110 may use an anchor rule configured to identify numerical tokens such as “−6.14” from input data 132. In another example, information extractor 110 may process input data 132 to using anchor seeds of anchor rules 109 that are configured to identify one or more words that are expected to be part of a target entity (e.g., “density”, frequency”, etc.) In another example, information extractor 110 may use an anchor rule from anchor rules 109 to match phrases such as “is broken”, “isn't working”, or “doesn't function” to identify the names products in a document collection recording technical support interactions. The anchor rule may use finite-state methods to identify adjacent product names. Alternatively, it may exploit syntactic relations, such as that a product name may be a noun phrase that is the subject of the anchor phrases.

Information extractor 110, based on tokenizing input data 132, may apply one or more rules of rules 107 that are configured to identify token class expressions. Rules 107 may includes one or more rules that are configured to classify the tokens. For example, information extractor may apply rules 107 to identify tokens that are words with particular affinities (e.g., scientific units such as “amp”, “volts”, etc.).

Information extractor 110 may apply one or more other rules or rules 107 to identify relations between the classified tokens and to elaborate the internal structure of phrases that include the tokens. In the example of FIG. 3, information extractor 110 identifies relations among tokens that underpin the entities of metrics 362 and measurements 364. Information extractor 110 identifies the entities based on their relations within an overarching relation such as assertions 360. Information extractor 110 may identify relations that are combinations of entities. In some examples, information extractor 110 may identify relations that are discontinuous within text analyzed by information extractor 110. Information extractor 110 may employ one or more techniques such as contextual contraction, phrasal expansion, and internal expansion to identify relations among tokens and phrases. In another example, information extractor 110 may identify words that delimit phrases (e.g., the “a” in front of “short-circuit current” may delimit that phrase).

Information extractor 110 may provide data regarding processed sections of data from input data 132 to user 119 for review. For example, information extractor 110 processes input data 132 and identifies assertions 360 within input data 132. Information extractor 110 identifies assertions 360 that include metrics 362 and measurement 364. Information extractor 110 may indicate relations among tokens and phrases provided to user 119 by color coding the one or more tokens and phrases according to the relations among them.

User 119 may leverage assertions 360 in developing rules for rules 107 such as anchor rules. For example, user 119 may use the identification of particular words in refining anchor rules 109 to reduce the rate of identification as tokens sought by the IE model rules 107. In another example, user 119 may modify one or more rules to add to the tokens used as delimiters for phrases and reduce the scope of the phrases.

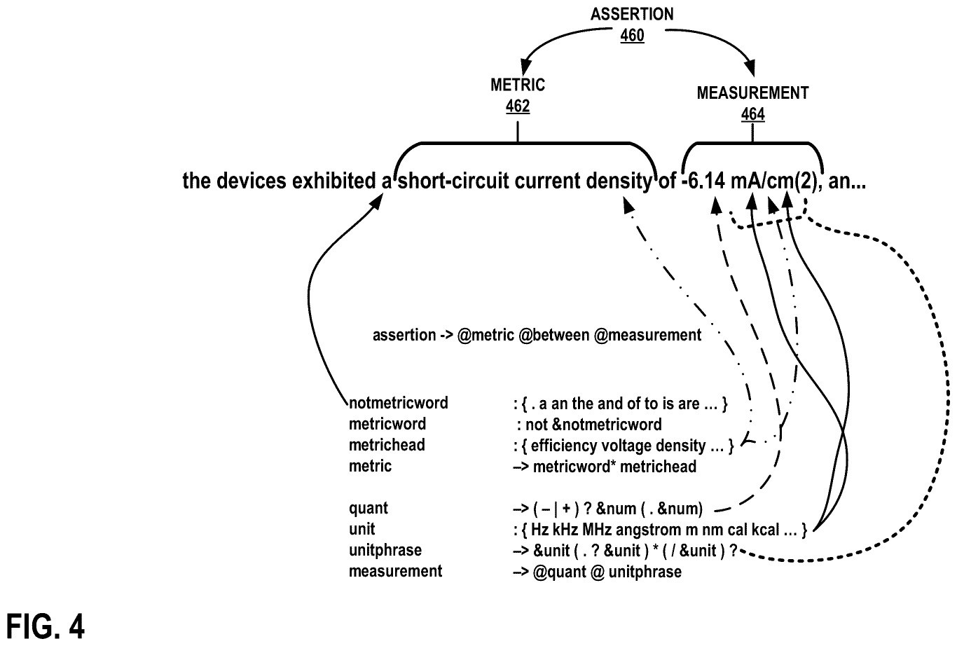

FIG. 4 is a diagram illustrating an excerpt of a rule set, in accordance with one or more techniques of this disclosure. As shown in the example of FIG. 4, an example digital text includes assertion 460, metric 462, and measurement 464. For the purposes of clarity, FIG. 4 will be described in the context of FIG. 1.

Information extractor 110 may identify phrases such as metric 462 and measurement 464. Information extractor 110 may first identify tokens within the example digital text (e.g., individual words such as “current”, “of”, “devices”, etc.). Information extractor 110 may identify the tokens based on the probabilistic analysis of the characters of the tokens indicating that the characters form a word.

Information extractor 110 may identify expressions from the tokens using one or more anchor rules. Information extractor 110 may identify expressions such as metric 462 and measurement 464. Information extractor 110 may use rules such as those illustrated below the example digital text to identify the expressions (e.g., “notmetricword” used to identify word that are not part of metric 462, “unit” rule is used to identify scientific measurements that are part of a measurement expression such as measurement 464). Additionally, in the example of FIG. 4, information extractor 110 may use the anchor rule “quant” to build the word list named “unit”. Further, information extractor 110 may use rules targeted to identify language using structural and orthographic regularities (e.g., measurement 464 will include some sort of numeric component). In another example, information extractor 110, for expression that lack orthographic clues, may use special-purpose lexicons that list the particular tokens that occur within the expression (e.g., metric 462 may not include numeric tokens, but will include tokens such as “amperage”, “voltage”, “current density”, etc.). Information extractor 110 may additionally identify, using rules 107, expressions using qualifiers to tokens (e.g., “short-circuit” as a prepended to the key head words “current density”). In addition, information extractor 110 may identify intervening language between the expressions of metric 462 and measurement 464 (e.g., using a “@between” rule not illustrated). Further, information extractor 110 may use delimiting rules such as “notmetricword” to identify boundaries to the expressions.

Information extractor 110 may identify assertions such as assertion 460. Information extractor 110 may identify assertion 460 based on the identification of adjoining metrics and measurements. In the example of FIG. 4, information extractor 110 uses the rule “@metric @between @mesaurement” to define the composition of an assertion. For example, information extractor 110 may identify metric 462 and measurement 464 as being in proximity and with a bridging word or phrase defined by the “@between” rule between the expressions. Based on the presence of an expression such as metric 462 being within a proximity of another expression such as measurement 464 with a bridging token in between the two expression, information extractor 110 may determine using probabilistic analysis that assertion 460 includes the two expressions.

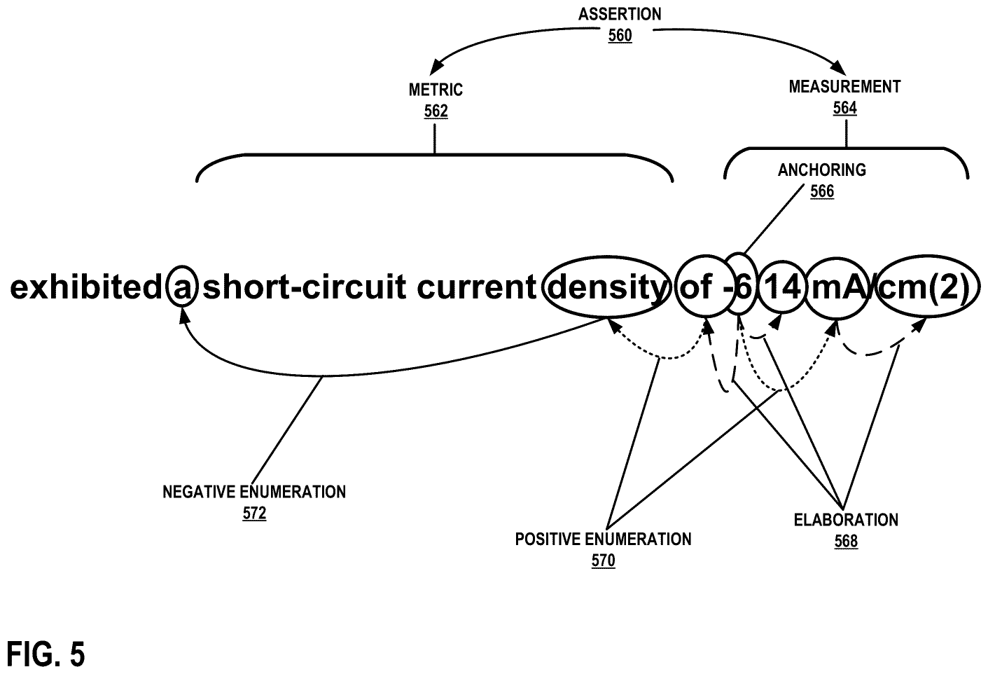

FIG. 5 is a diagram illustrating an example sequence of operations of authoring a rule set, in accordance with one or more techniques of this disclosure. As shown in the example of FIG. 5, an example digital text includes assertion 560, where assertion 560 include measurement 564 and metric 562. For the purposes of clarify, FIG. 5 will be discussed in the context of FIG. 1.

Information extractor 110 may process input data 132 and extract one or more relations among words and phrases from input data 132. For example, information extractor 110 may extract assertion 560, measurement 562 and metric 564 as parts of a relation within the text represented by assertion 562. In the example of FIG. 5, metric 564 includes the text “short-circuit current density” and measurement 562 includes the text “−6.14 mA/cm(2)”.

Information extraction system 100 may use one or more processes or procedures to author rules to extract assertions from the text of input data 132. In the example of FIG. 5, information extractor 110 uses anchoring 566, elaboration 568, positive enumeration 570, and negative enumeration. Information extraction system 100 may use one or more processes or sequences of operations to author a rule set to extract assertions such as the assertion 562 of FIG. 5 that includes metric 564 and measurement 562.

Information extraction system 100 may perform anchoring 566 as part of authoring a rule set to extract assertions such as assertion 560. Anchoring 566 includes generating a comparatively simple rule that may overgenerate the identification of tokens and expressions by design and match all textual regions in which sought expressions are expected to be found. As part of anchoring 566, a technician such as user 119 may draft the rules associated with anchoring 566 (e.g., anchor rules 109). For example, training module 112 may update anchor rules 109 in response to input from user 119 via user device 120. In an example, training module 112 receives an anchor rule that extracts numeric portions of assertion 562 (e.g., measurement 562). In some examples, anchoring 566 may be performed using an anchor rule of anchor rules 109 that is configured to identify a large number of candidates of measurement 562 and lead to further refinement of anchor rules 109.

Information extraction system 100 may perform elaboration 568 as part of authoring a rule set. Elaboration 568 may be an internal and/or contextual process and expand the tokens identified using an initial anchor rule. For example, as part of elaboration 568 information extraction system 100 may expand the internal structure of the targeted phrases and expressions based on the matched tokens and sub-phrases. In addition, information extraction system 100 may use contextual elaboration to characterize tokens and language that act as bridges between target entities (e.g., the “of” between metric 562 and measurement 564). In some examples, user 119 may refine rules 107 during elaboration 568 by, within a user interface, dragging a cursor over a phrase and determining whether computing system 102 provides an accurate elaboration of the phrase (e.g., a phrase's relation with other entities) as a form of grammar inference.

Information extraction system 100 may perform one or more types of grammar inference during elaboration 568. For example, information extraction system 100 may perform an inference based on user 119 indicating that “6” should be followed by “0.14”. Information extraction system 100, based on the indication, determine that the pattern “num.num” is a common pattern to one or more expressions within a textual region. In another example, information extraction system 100 may implement a rule that characterizes the “14” of the expression measurement 564.

Information extraction system 100 may perform enumeration as part of authoring a rule set. A rule developer, such as user 119, may perform enumeration to author the rule set using the anchor rules as a basis. User 119 may perform positive enumeration 570 and negative enumeration 572 as part of performing enumeration on selected portions of text. User 119 may perform enumeration using a core component that is expanded using tokens that are identified in proximity to a current rule set. For example, using a user interface provided by user device 120 user 119 may identify tokens that are associated with the numeric portion of the expression measurement 564. Computing system 102 may provide information regarding associated tokens in response to receiving information regarding a selection by user 119 of a particular token. In addition, user 119 may perform enumeration to exploit co-occurrence statistics to infer lexical affinities within the text. Further, information extraction system 100 may infer affinities such as embeddings or other types of vector relations in response to a request by user 119 to identify lexical affinities. For example, computing system 102 may provide a list of semantically comparable tokens related to a token selected by user 119 to user device 120. Computing system 102 may provide the list of tokens to enable a developer such as user 119 to refine anchor rules 109, as well as select a different subset to define a new token class.

Information extraction system 100 may perform positive enumeration 570 and negative enumeration 572. Positive enumeration 570 and negative enumeration 572 may include may one or more processes performed by information extraction system 100. For example, positive enumeration 570 may include specifying the tokens that appear in a particular context within an extraction target. In an example, positive enumeration may identify the head word of a particular expression such as “density” of metric 562 or unit abbreviations of measurement 562. Positive enumeration 562 may identify head words that are used in identifying expressions such as metric 562 and measurement 564. Information extraction system 100 may additionally perform negative enumeration 572. Negative enumeration 572 may identify words and tokens that act as limit to extraction targets. For example, as part of negative enumeration 572, information extraction system 100 may identify the “a” preceding metric 562 as a stop word used to delimit the scope of metric 562.

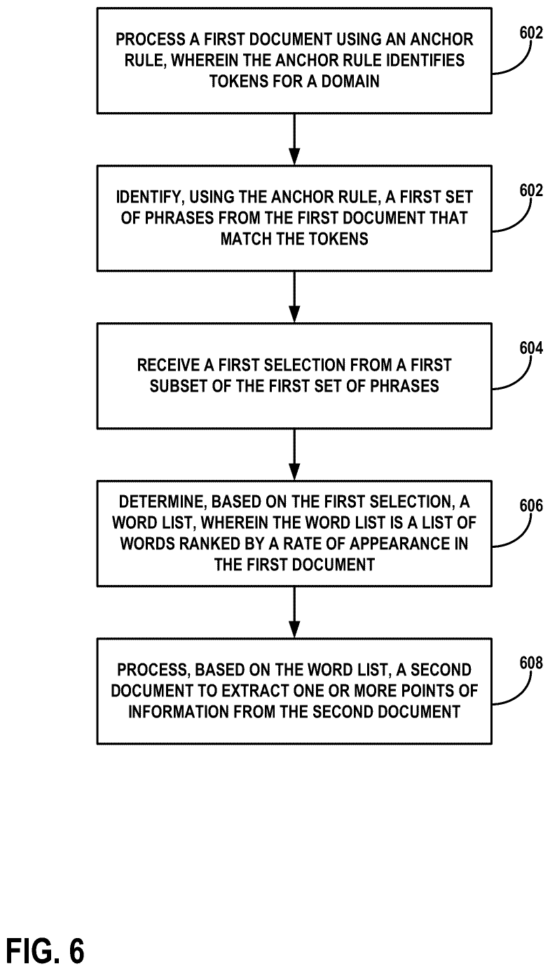

FIG. 6 is a flow chart illustrating an example operation of an information extraction system, in accordance with one or more techniques of this disclosure. For the purposes of clarity, FIG. 6 will be discussed in the context of FIG. 1.

A computing system, such as computing system 102, processes a first document using an anchor rule, such as anchor rules 109, wherein anchor rules 109 identify tokens for a domain (602). Computing system 102 may process the first document as a first document in a plurality of documents to be processed for information extraction or process multiple additional documents in addition to the first document. Computing system 102 may process the document using information extractor 110 that includes one or more rules-based or finite-state machines of rules 107. Computing system 102 may identify tokens for a domain such as particular words associated with assertions regarding physics measurements (e.g., solar panel efficiency, current density, voltage drop, etc.). Computing system 102 may process the first document and/or the plurality of documents using anchor rules 109 to identify useful words and phrases for authoring further rules.

Computing system 102 identifies, using the anchor rule of anchor rules 109, a first set of phrases from the first document that match the tokens (604). Computing system 102 may identify phrases that include metrics and measurement of assertions sought by computing system 102. For example, computing system 102 may identify a phrase that is a numerical value. Computing system 102 may provide the identified first set of phrases to a developer such as user 119 via user device 120 for analysis and refinement of the anchor rule of anchor rules 109. In some examples, computing system 102 may provide a subset of the first set of phrases to user 119 that is representative of the whole of the identified phrases.

Computing system 102 receives a first selection from a first subset of the first subset of phrases (604). Computing system 102 may receive a first selection from a developer such as user 119 via computing device 120. Computing system 102 may receive a selection that indicates which phrases should be used for further development of a rules-based extraction model such as rules 107.

Computing system 102 determines, based on the first selection, a word list such as word lists 113, wherein word lists 113 is a list of words ranked by a rate of appearance in the first document (606). Computing system 102 may determine a list of words that include information regarding relations among the words and other words/phrases of the first document. For example, computing system 102 may determine a list of words that include assertions that are further comprised of metrics and measurements such as information regarding solar panel efficiency over time. In some examples, computing system 102 may process the first document using anchor rules 109 that have been updated based on word lists 113.

Computing system 102 processes, based on word lists 113, a second document to extract one or more points of information from the second document (606). Computing system 102 may process a second document of input data 132 and output the points of information as output data 138. Computing system 102 may process the second document to extract information from the second document. In some example, computing system 102 may process the second document using a machine learning model trained using rules 107.

Systems and techniques are described in this disclosure for using expert-created extraction rules to train ML models directly, thereby bypassing the expensive annotation step. For example, the following disclosure describes an ML system that facilitates the creation of rules by users and application of the rules to an ML model for information extraction. The ML system may use rule frameworks to perform information extraction from unstructured data (e.g., the conversion of statements in natural language into structured records suitable for downstream computation). The ML system may facilitate user (e.g., human) rule creation with automation, using machine learning applied to a target document collection and rules under construction.

The ML system may target the creation of special-purpose word lists or lexicons. In some cases, the ML system may use corpus analysis, whether based on information theory (e.g., SRI International's Jminer software) and/or drawing on word embeddings, to reduce the labor requirements. The ML system may facilitate the process of creating semantic lexicons and user creation of rules. In this way, the techniques target certain steps in the rule creation process that are labor-intensive.

The above examples, details, and scenarios are provided for illustration, and are not intended to limit the disclosure in any way. Those of ordinary skill in the art, with the included descriptions, should be able to implement appropriate functionality without undue experimentation. References in the specification to “an embodiment,” “configuration,” “version,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Examples in accordance with the disclosure may be implemented in hardware, firmware, software, or any combination thereof. Modules, data structures, function blocks, and the like are referred to as such for ease of discussion and are not intended to imply that any specific implementation details are required. For example, any of the described modules and/or data structures may be combined or divided into sub-modules, sub-processes or other units of computer code or data as may be required by a particular design or implementation. In the drawings, specific arrangements or orderings of schematic elements may be shown for ease of description. However, the specific ordering or arrangement of such elements is not meant to imply that a particular order or sequence of processing, or separation of processes, is required in all embodiments.

In general, schematic elements used to represent instruction blocks or modules may be implemented using any suitable form of machine-readable instruction, and each such instruction may be implemented using any suitable programming language, library, application programming interface (API), and/or other software development tools or frameworks. Similarly, schematic elements used to represent data or information may be implemented using any suitable electronic arrangement or data structure. Further, some connections, relations or associations between elements may be simplified or not shown in the drawings so as not to obscure the disclosure. This disclosure is to be considered as exemplary and not restrictive in character, and all changes and modifications that come within the spirit of the disclosure are desired to be protected.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules, engines, or components may be implemented together or separately as discrete but interoperable logic devices. Depiction of different features as modules, engines, or units is intended to highlight different functional aspects and does not necessarily imply that such modules, engines or units must be realized by separate hardware or software components. Rather, functionality associated with one or more modules, engines, or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, processing circuitry, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), Flash memory, a hard disk, a CD-ROM, a floppy disk, a cassette, magnetic media, optical media, or other computer readable media. A computer-readable medium may include any mechanism for storing or transmitting information in a form readable by a machine. For example, a computer-readable medium may include any suitable form of volatile or non-volatile memory. In some examples, the computer-readable medium may comprise a computer-readable storage medium, such as non-transitory media. The term “non-transitory” may indicate that the storage medium is not embodied in a carrier wave or a propagated signal. In certain examples, a non-transitory storage medium may store data that can, over time, change (e.g., in RAM or cache).

What is claimed is:

1. A method, comprising:
processing, by a computing system, a first document using an anchor rule, wherein the anchor rule identifies tokens for a domain;
identifying, by the computing system and using the anchor rule, a first set of phrases from the first document that match the tokens;
receiving, by the computing system, a first selection from a first subset of the first set of phrases;
determining, by the computing system and based on the first selection, a word list, wherein the word list is a list of words ranked by a rate of appearance in the first document; and
processing, by the computing system and based on the word list, a second document to extract one or more points of information from the second document.

2. The method of claim 1, further comprising:
receiving, by the computing system, a user selection of one or more matching phrases from the first subset of the first set of phrases from a displayed user interface; and
outputting an indication of one or more candidate words for a word list.

3. The method of claim 2, further comprising selecting, by the computing system, the first subset of the first set of phrases using at least one of:
a frequency of occurrence of one or more phrases within the first set of phrases, corpus analysis of the first document, or
one or more embeddings.

4. The method of claim 2, further comprising:
receiving, by the computing system, a user selection of two or more words from the first subset of the first of phrases from the displayed user interface; and
displaying, by the computing system, grammatical relationships among the two or more words.

5. The method of claim 2, further comprising based on receiving a user selection, displaying, by the computing system, one or more grammatical relationships.

6. The method of claim 2, further comprising:
responsive to the selection of the one or more matching phrases, updating, by the computing system, one or more other rules within a rule set, wherein the rule set includes the anchor rule and the one or more other rules, and wherein the anchor rule is a static rule;
processing, by the computing system, the first document using the updated rule set; and
identifying, by the computing system and using the updated rule set, a second set of phrases from the first document that match the tokens.

7. The computing system of claim 6, wherein processing the first document using the anchor further comprises processing the first document using a machine learning (ML) model, and further comprising:
training, by the computing system, the ML model based on the updated rule set.

8. The method of claim 1, wherein the anchor rule includes entity expressions used in assertions regarding at least one of quantitative claims or observations in the scientific literature; relationships among people and organizations reported in the news; the parties and findings in legal documents involved in litigation; products, business entities, prices, in documents detailing business transactions; or other domains involving textual communication.

9. The method of claim 8,
wherein the claim expressions include measurement expressions and metric expressions,
wherein the measurement expressions are quantitative claims or observations, and
wherein the metric expressions correspond to the measurement expressions and are quantitative values of the quantitative expressions.

10. The method of claim 9, further comprising determining, by the computing system and based on the claim expressions, one or more relationships among the claim expressions.

11. The method of claim 1, wherein extracting the one or more points of information further comprises determining one or more relationships between words of the second document.

12. The method of claim 1, further comprising processing, by the computing system, multiple additional documents in addition to the first document, using the anchor rule.

13. The method of claim 1, wherein the anchor rule is a first anchor rule, wherein the word list is a first word list, and further comprising responsive to determining the first word list:
processing, by the computing system, the first document using a second anchor rule, wherein the second anchor rule is based on the first word list;
identifying, by the computing system and using the second anchor rule, a second set of phrases from the first document that match the tokens;
receiving, by the computing system, a second selection from the first subset of the first set of phrases;
determining, by the computing system and based on the second selection, a second word list; and
processing, by the computing system and based on the second word list, the second document to extract one or more points of information from the second document.

14. A computing system, comprising:
a memory; and
one or more programmable processors in communication with the memory, and configured to:
process a first document using an anchor rule, wherein the anchor rule identifies tokens for a domain;
identify, using the anchor rule, a first set of phrases from the first document that match the tokens;
receive a first selection from a first subset of the first set of phrases;
determine, based on the first selection, a word list, wherein the word list is a list of words ranked by a rate of appearance in the first document; and
process, based on the word list, a second document to extract one or more points of information from the second document.

15. The computing system of claim 14, wherein the one or more programmable processors are further configured to:
receive a user selection of one or more matching phrases from the first subset of the first set of phrases from a displayed user interface; and
output an indication of one or more candidate words for a word list.

16. The computing system of claim 15, wherein the one or more programmable processors are further configured to select the first subset of the first set of phrases using at least one of:
a frequency of occurrence of one or more phrases within the first set of phrases, corpus analysis of the first document, or
one or more embeddings.

17. The computing device of claim 13, wherein the one or more programmable processors are further configured to:
responsive to the selection of the one or more matching phrases, update one or more other rules within a rule set, wherein the rule set includes the anchor rule and the one or more other rules, and wherein the anchor rule is a static rule;
process the first document using the updated rule set; and
identify, using the updated rule set, a second set of phrases from the first document that match the tokens.

18. The computing device of claim 17, wherein processing the first document using the anchor rule further comprises process the first document using a machine learning (ML) model, and wherein the one or more programmable processors are further configured to:
train the ML model based on the rule set.

19. The computing device of claim 12, wherein the anchor rule includes entity expressions used in assertions regarding at least one of quantitative claims or observations in the scientific literature; relationships among people and organizations reported in the news; the parties and findings in legal documents involved in litigation; or products, business entities, prices, in documents detailing business transaction, or other domains involving textual communications.

20. Non-transitory computer-readable media, comprising instructions that, when executed, cause one or more processors to:
process a first document using an anchor rule, wherein the anchor rule identifies tokens for a domain;
identify, using the anchor rule, a first set of phrases from the first document that match the tokens;
receive a first selection from a first subset of the first set of phrases;
determine, based on the first selection, a word list, wherein the word list is a list of words ranked by a rate of appearance in the first document; and
process, based on the word list, a second document to extract one or more points of information from the second document.
